(19) United States
(12) Patent Application Publication
(10) Pub. No.: US 2005/0228681 A1
(43) Pub. Date: Oct. 13, 2005

(54) Data extraction tool and methods of use

(75) Inventor: Alan McMahon, Bonnybridge (GB)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: United Parcel Service of America, Inc.

(21) Appl. No.: 10/821,540

(22) Filed: Apr. 9, 2004

(51) Int. Cl. G06F 17/60

(52) U.S. Cl. 705/1

(57) ABSTRACT

The present invention is directed to system and methods for processing parcel level detail (PLD) data received by a shipping system. The shipping system stores the PLD data in a file and associates the PLD data with a tracking number. Based on criteria defined in an extraction configuration file, the shipping system extracts selected data from the PLD data file and writes it to a separate file. The shipping system then communicates the extracted data to a destination based on criteria defined in a communication parameter data file. The shipping system may also transmit the PLD data file to a server operated by the parcel delivery service.

### FIELD OF THE INVENTION

This invention is directed generally to shipping systems and more particularly to shipping systems that receive parcel level detail data from a user and where the shipping system is capable of allowing selective shipping information to be extracted and sent in a format to a destination defined by the user of the shipping system.

### BACKGROUND OF THE INVENTION

Parcel delivery companies, such as UNITED PARCEL SERVICE, maintain computerized shipping records for the purposes of tracking parcels. Traditionally, a shipping customer obtains tracking information by calling a customer service representative, who accesses his or her company's computer system and relays the requested information to the customer. Parcel shipping records are manually keyed into a company's computer system from parcel shipping forms, which are completed by customers. Thus, to provide an interface between parcel delivery companies and customers, this method of shipping and tracking parcels requires the use of key entry operators and customer service representatives. Consequently, the method is both labor intensive and costly. Moreover, the method can be frustrating for customers when no customer service representative is immediately available to provide needed information.

More recently, parcel delivery companies have developed tracking software that operates in a personal computer environment. The tracking software permits customers to directly access a delivery company's computer system and obtain needed information. Thus, customers with a personal computer and the tracking software no longer need to interact with a customer service representative every time information is required. Accordingly, the tracking software permits delivery companies to operate more efficiently because fewer customer service representatives are needed.

Parcel delivery companies have similarly developed shipping software for customers allowing customers to enter their shipping records into personal computers, from where the records are uploaded to the delivery company's computer system. Accordingly, the shipping records no longer need to be manually keyed into the delivery company's computer system. Further, the shipping software prints machine readable parcel labels that allow the parcels to be machine sorted, which is both more efficient and more accurate. Thus, the shipping software, along with the tracking software, permits parcel delivery companies to provide shipping customers with improved, more efficient service.

These shipping systems typically prompt, accept, and verify package level detail (PLD) data provided by the shipping customer, write the PLD data to a file, and then transmit the file to a second computer, such as a server, operated by the parcel delivery company. The data transmitted typically also includes the tracking number. However, some shipping customers require access to the data sent to the parcel delivery company's computers. Specifically, other persons or computer systems associated with the shipping customer require access to the shipping data, including the tracking number. Further, access to the PLD data may be required in real-time or near real-time. For example, a web site of a mail-order business accepting orders from purchasers may provide the purchaser with a tracking number at the completion of the order, even though the items have not been picked, packed, or shipped. Frequently, it is necessary that the shipping department know the tracking number in order to properly complete the packing and shipping functions. In other applications, the shipping department may interact with a shipping system while another department in the business may require access to the shipping data, such as the tracking number for other procedures. For example, a single order may comprise two shipped parcels. A mail order business may wish to provide notification to the customer that their order has been shipped in multiple parcels. This requires that the mail-order business computer system have access to shipping information in a timely manner in order to notify the customer.

Thus, systems and methods are required for other individuals and other systems to have real time access to shipping information, such as the tracking number. Further, there is a need to allow the user of the shipping system define what data is sent to which location, and how the communication is to occur.

### BRIEF SUMMARY OF THE INVENTION

In one embodiment of the invention, a method is defined for processing parcel level detail (PLD) data by providing PLD data associated with a parcel to a shipping system, determining a tracking number associated with the parcel, storing the PLD data in association with the tracking number in a record in a database, extracting selected portions of the PLD data from the record, transmitting the selected data to a predetermined destination, and transmitting the PLD data to a second computer.

In another embodiment of the present invention, computer readable software is defined for receiving PLD data associated with a parcel in a shipping system, determining a tracking number associated with the parcel, storing the PLD data in a database along with the tracking number in a record in a database, extracting selection portions of the PLD data from the record, and transmitting the extracted portions to a predetermined destination.

In another embodiment of the present invention, an apparatus is defined comprising a database for storing a plurality of records comprising PLD data including a tracking number, the database further storing criteria for extracting portions of the PLD level data, the database further storing an address and communication parameters to send the extracted portions of the parcel level data, and a processor configured for receiving input comprising PLD data, storing the PLD level shipping data in a record in the database, the processor also configured to extract and transmit the extracted PLD shipping data to the address using the communication parameters.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1a discloses one embodiment of a computer adapted as a shipping system that can be used to practice the principles of the present invention.

FIG. 1b discloses one embodiment of the shipping system interacting with a server operated by the parcel delivery provider.

FIG. 2 discloses one embodiment of the processing involved in a shipping system according to the principles of the present invention.

FIG. 3 discloses one embodiment of a PLD data file and an associated extracted data file according to the principles of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

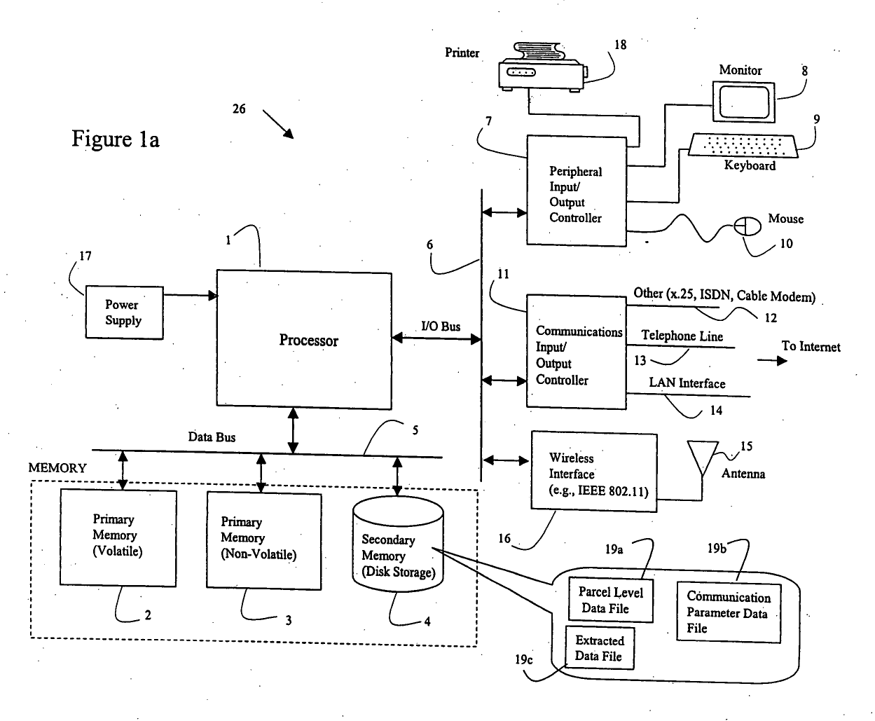

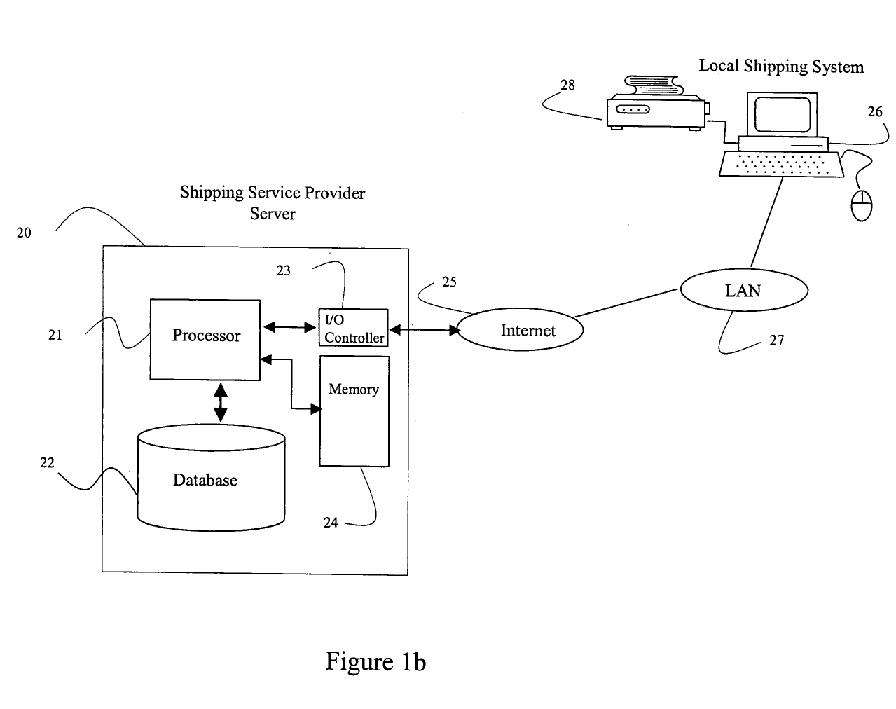

Turning to FIG. 1a, one embodiment of a shipping system 26 comprising a computer is illustrated that can be used to practice aspects of the present invention. In FIG. 1a, a processor 1, such as a microprocessor, is used to execute software instructions for carrying out the defined steps. The processor receives power from a power supply 17 that also provide power to the other components as necessary. The processor 1 communicates using a data bus 5 that is typically 16 or 32 bits wide (e.g., in parallel). The data bus 5 is used to convey data and program instructions, typically, between the processor and memory. In the present embodiment, memory can be considered primary memory 2 known as RAM, and/or it may be non-volatile memory 3, such as ROM, EPROM, EEPROM, FLASH, or other types of memory that retain the memory contents absent the application of power. The memory could also be secondary memory 4, such as disk storage, that stores large amount of data, albeit with slower access times. The disk storage typically stores several files, including a parcel level detail (“PLD”) data file 19a that includes data entered by the user about a shipped parcel. The disk storage also stores the extracted data file 19c that is the PLD data that is extracted and communicated to the defined location. The disk storage also stores a communication parameter data file 19b that includes data about where and how the extracted PLD data is to be communicated. In some embodiments, the disk storage may communicate with the processor using an I/O bus 6 instead or some other dedicated bus (not shown). The secondary memory may be a floppy disk, hard disk, compact disk, DVD, or any other type of mass storage type known to those skilled in the computer arts.

The processor 1 also communicates with various peripherals or external devices using an I/O bus 6. In the present embodiment, a peripheral I/O controller 7 is used to provide standard interfaces, such as RS-232, RS422, DIN, USB, or other interfaces as appropriate to interface various input/output devices. Typical input/output devices include local printers 18 that can be used to print labels for parcels, a monitor 8, a keyboard 9, and a mouse 10 or other typical pointing devices (e.g., rollerball, trackpad, joystick, etc.). Typically, the user entering shipping data will use keyboard input for providing data, although the mouse can be used to select data from menus. Other technology, such as speech recognition (not shown), can be used.

The processor 1 typically also communicates using a communications I/O controller 11 with external communication networks, and may use a variety of interfaces such as data communication oriented protocols 12 such as X.25, ISDN, DSL, cable modems, etc. Typically, the communication interface is used by the shipping system to communicate with a server (not shown in FIG. 1a) operated by the shipping carrier. Alternatively, or in addition, the communications controller 11 may also incorporate a modem (not shown) for interfacing and communicating with a standard telephone line 13. Finally, the communications I/O controller may incorporate an Ethernet interface 14 for communicating over a LAN. Any of these interfaces may be used to access the Internet, intranets, LANs, or other data communication facilities.

Finally, the processor 1 may communicate with a wireless interface 16 that is operatively connected to an antenna 15 for communicating wirelessly with other devices, using for example, one of the IEEE 802.11 protocols, 802.15.4 protocol, or a standard 3G wireless telecommunications protocols, such as CDMA2000 1x EV-DO, GPRS, W-CDMA, or other protocol. This may be used to communicate with wireless-based bar code reader (wands, gun-type readers, or other forms of portable terminals).

Turning to FIG. 1b, the shipping system 26 functions as a local shipping system relative to the user and remote relative to a server operated by the parcel delivery company. This relationship is illustrated in the embodiment of FIG. 1b. In this embodiment, a server 20, is typically operated by the parcel delivery company and communicates with the local shipping system 26. Although only one local shipping system is shown, typically there are many local shipping systems associated with various users that can communicate with the server. The server 20 typically comprises a processor 21 that communicates with a database 22, which can be viewed as a form of secondary memory, as well as primary memory 24. The processor also communicates with external devices using an I/O controller 23 that typically interfaces with the Internet 25. The Internet in turn connects to a LAN 27 that may provide local connectivity between the printer 28 and the local shipping system 26. Communication between the server 20 and the local shipping system 26 typically is accomplished by routing data from the LAN 27 over a communications facility to the Internet 25. The local shipping system 26 may interact with the server in a client-server manner in which the local shipping system executes a web-based browser. Alternatively, the local shipping system may interact with the server on a peer-to-peer or master-slave basis.

Those skilled in the art of data networking will realize that many other alternatives and architectures are possible that can be used to practice the principles of the present invention. The embodiments illustrated in FIGS. 1a and 1b can be modified to use other technologies and still be within the scope of the present invention as claimed.

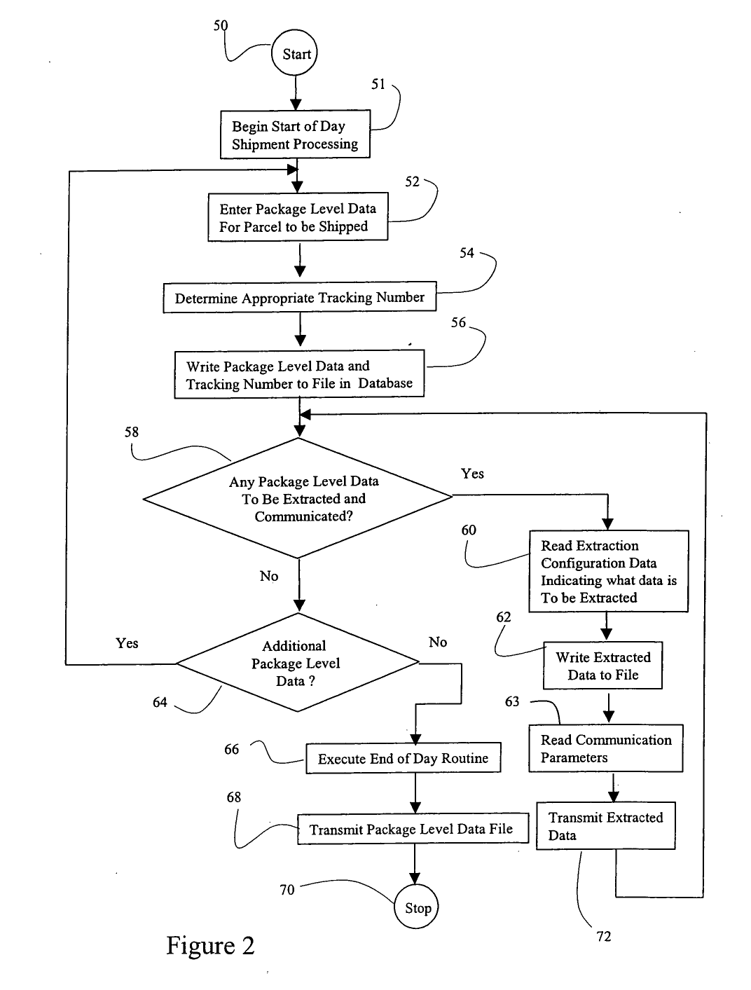

The process associated with the operation of the local shipping system is illustrated in FIG. 2. FIG. 2 illustrates one embodiment of various steps that are associated with the present invention. The process starts at the first step 50 in which the user performs the typical functions of powering on the system and starting the shipping system application. In a typical embodiment, the local shipping system is equipped and executing a Microsoft Windows™ operating system. After booting up the system, the user may use the pointing device to select an icon that is a ‘shortcut’ to start the shipping application. In other embodiments, the application may automatically start up upon booting. In addition, another application, the data extraction application, which may be coded in Visual Basic or another programming language, executes simultaneously. In other embodiments, the data extraction application may be integrated or designed into the shipping application.

The shipping application is typically initiated on a daily basis. This is reflected in step 51 in which the “Start-of-Day” routine is executed. This prepares the system for receiving shipping data. At step 52, parcel data is entered for a parcel to be shipped. The data entered comprises, in one example, destination name, address, city, state, and zip code. This may be individually entered or entered by selecting a name from an address book. In addition, the user selects a class of service (such as next day delivery, air delivery, ground, etc.). Other service aspects may be indicated, such as COD, insurance, proof of delivery, etc. The weight of the parcel may be provided manually or this may be communicated automatically using a scale interfaced to the local shipping system that provides the weight to the shipping application (the scale is not shown in FIG. 1). Various other types of shipping information may be provided as is known to those skilled in the art of shipping systems.

The local shipping system then typically obtains a parcel tracking number in step 54. The tracking number may be determined in a number of different ways. First, the local shipping system may query in real-time the shipping service provider's server to request a tracking number. Alternatively, the local shipping system may retain a local ‘inventory’ of tracking numbers in a file that it selects and allocates for each parcel as required. The inventory of tracking numbers may be replenished daily, periodically, or according to some other algorithm, either by manual entry or by automatically communicating with the shipping service provider's server. Finally, the local shipping system may use an algorithm for establishing a unique tracking number, including using data based on the time of day, local shipping system identifier, or some other unique data to generate the tracking number. Thus, there are a variety of methods that be used by the local shipping terminal to obtain the tracking number.

Regardless of how the local shipping system obtains the tracking number, the shipping system stores the tracking number and the PLD data in step 56. This data is typically stored in a record in a database, with each of the different type of information stored in different fields. The records are stored in a PLD data file that stores all the records for parcels being shipped. The local shipping system may store the data using a commercial database software, such as Microsoft Access™, or various other types of relational or SQL databases.

In step 58, the data extraction process is disclosed. The data extraction process may be illustrated and implemented in different ways, but can be logically thought of as a process executing in the background that extracts selected data from the PLD data file and transmits the extracted data to a defined location in a defined manner. The data extraction process can execute periodically, on-demand, or based on some other criteria.

In step 58 the decision of whether data should be extracted is performed. If there is data to be extracted, then step 60 is performed. The local shipping system is programmed to select certain fields from the PLD record. These selected fields for extraction are defined by an extraction configuration data file. The system reads the extraction configuration data file (if it has not already done so) and uses this to determine which fields to extract. The local shipping system then writes the extracted data into a file at step 62. Next, the shipping system retrieves the communication parameters defined in step 63. These parameters indicate how and where the extracted data is to be transmitted. For example, the data may be sent in an email message, a specific application level protocol message, via a dial-up connection to a particular telephone number, or an EDI message to another system. Further, the communication parameters may indicate a plurality of locations that receive the same or different data, based on certain time-of-day criteria, or other criteria (e.g., upon detecting a buffer full condition, after the expiry of a time, or as requested by user input). Once the extracted data is transmitted in step 72, the data extraction routine returns control to the main processing flow at step 58.

At step 58, if there is no data to be extracted and communicated, the local shipping system waits for additional PLD data input associated with a parcel at step 64. If there are additional parcels to be shipped, the process returns to step 52 to receive the additional parcel input data. Otherwise, the local shipping system is then “closed out” for the day by executing the “end-of-day” routine. This routine typically then sends the parcel level data file to the server in step 68 before terminating the application in step 70.

Those skilled in the art of software design will readily appreciate that the logic flow for extracting data can be embodied in different ways and is not limited to the disclosed embodiment. For example, the logic could be executed serially, or as a separate, but simultaneous thread, as a background process, or interrupt process based on a timer.

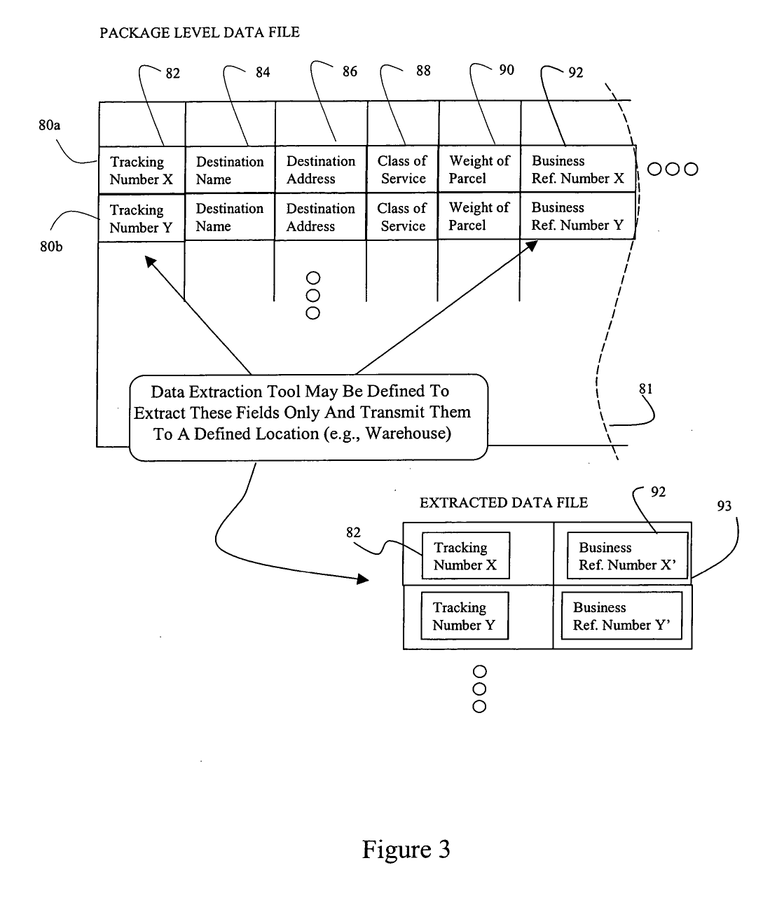

FIG. 3 illustrates one embodiment of the parcel level data file 81 and the extracted data file 93. In FIG. 3, the parcel level data file 81 comprises a number of records 80a, 80b that each typically represents the PLD data associated with a parcel. The record typically comprises a number of fields, and in the present embodiment, the first field is the tracking number 82. This may be determined by any of the aforementioned or other means. Other fields include the destination address information, including destination name 84, class of service 88, weight of the parcel 90, and a business reference number 92. The business reference number may not always be present, but is often used to by the user's business systems to correlate the parcel with some internal business identifier, such as a purchase order number, project number, client number, etc. Further, this is not limited to being a numeric field, but could be alphanumeric. Although this may not be part of the shipping data required by the local shipping system (e.g., in that it is required by the shipper to ship the parcel), it may be nonetheless stored as PLD type data in the local shipping system.

In the embodiment of FIG. 3, the data extraction application is defined by the user to extract two fields—the tracking number 82 and the business reference number 92. Thus, the local shipping system creates a separate extracted data file 93 that is stored in memory or in a database. The extracted PLD data typically has a record corresponding to each record in the PLD data file. In the present embodiment, the “tracking number X” parameter 82 from record 80a as well as the business reference number 92 is extracted and placed into the extracted data file 93 as an individual record. Similarly, a record is created corresponding to “tracking number Y” from record 80b. Those skilled in the art of database design will appreciate that this structure is but one approach for extracting and storing data, and that logical files can extracted without necessarily having to create separate physical files in memory.

The local shipping system provides a utility application that allows the user to configure and select which fields are extracted from the PLD data file. The utility application further allows the user to configure where and when the extracted data is sent to. This may be accomplished by allowing the user to select destination addresses and a timer defining the periodicity of the execution of the extraction process. The addresses typically are in email or URL, although various other forms may be used.

In the embodiment shown in FIG. 3, only two fields are shown as extracted, although any number of fields may be extracted. In the embodiment shown in FIG. 3, additional records to the extracted data file could be sent immediately or as defined by a timer (or other means). Thus, a shipping department fulfilling a purchase order may use the local shipping system to notify a billing system that a particular order number has been fulfilled and the customer should be billed. Many other applications for using the extracted data are possible and are not limited to the disclosed embodiment.

The principles of the claimed invention are not intended to be limited to the embodiments indicated in the above specification, but apply to other embodiments, implementations, and applications. The invention is only intended to be limited as defined in the following claims.

1. A method of processing parcel level detail (PLD) data associated with a parcel that is able to be tracked during shipment comprising:
providing a plurality of PLD data as input to a computer system;
determining a tracking number associated with the parcel;
associating the tracking number with the PLD data;
storing the PLD data and the tracking number in a record in a parcel data file stored in the computer system;
extracting at least a subset of the plurality of PLD data from the parcel data file based on an extraction configuration file stored in the computer system;
retrieving communication data parameters stored in the computer system, the communication data parameters comprising a first destination address;
transmitting an electronic communication message comprising the extracted subset of the plurality of PLD data and the tracking number to the first destination address; and
transmitting the parcel data file to a second computer.

2. The method of claim 1 wherein the tracking number is determined in part by selecting one of a plurality of tracking numbers stored in a tracking number inventory file in the computer system.

3. The method of claim 1 wherein the tracking number is determined in part by the computer system executing an algorithm producing the tracking number.

4. The method of claim 1 wherein the tracking number is obtained by requesting a server for the tracking number.

5. The method of claim 1 wherein the step of transmitting an electronic communication message occurs based on a pre-defined time schedule.

6. The method of claim 1 wherein the destination address is an email address.

7. The method of claim 6 wherein the email address is provided by an operator of the computer system.

8. The method of claim 1 further comprising transmitting a second electronic communication message including the tracking number to a second destination address.

9. The method of claim 1 wherein extracting at least a subset of the plurality of PLD data from the parcel data file based on an extraction configuration file stored in the computer system includes an business reference number associated with the parcel.

10. The method of claim 1 further comprising the steps of:
establishing a communications link between the computer system and a second computer;
transferring a plurality of tracking numbers from the second computer to the computer system; and
storing the plurality of tracking numbers in an tracking number inventory file in the computer.

11. A method of processing parcel level detail (PLD) data associated with a parcel that is able to be tracked during shipment comprising:
initiating a shipping application on a local shipping system;
providing a plurality of PLD data as input to a computer system wherein the plurality of PLD data include a destination address, class of service, and weight indication;
obtaining a tracking number;
associating the tracking number with the PLD data;
storing the PLD data and the tracking number in a record in a parcel data file stored in the computer system;
printing out a shipping label including at least a portion of the PLD data and the tracking number;
extracting at least a subset of the plurality of PLD data from the parcel data file based on an extraction configuration file stored in the computer system;
retrieving communication data parameters stored in the computer system, the communication data parameters comprising a first destination address;
transmitting an electronic communication message comprising the extracted subset of the plurality of PLD data and the tracking number to the first destination address; and
transmitting the PLD data file and the tracking number to a second computer.

12. A computer readable medium storing instructions to be executed on a computer comprising steps for:
receiving parcel level detail (PLD) data as input to the computer system, the PLD data associated with a parcel that is able to be tracked during shipment;
determining a tracking number associated with the parcel;
storing the PLD data and the tracking number in a record in a parcel data file;
extracting a portion of the PLD data;
retrieving a communication data parameter file comprising a user-defined destination address;
transmitting an electronic communication message comprising the portion of the PLD data and the tracking number to the destination address; and
transmitting the parcel data file to a second computer.

13. The computer readable medium of claim 12 wherein the portion of the PLD data is determined by an extraction configuration file.

14. The computer readable medium of claim 12 wherein the tracking number is determined by selecting one from a plurality of tracking numbers.

15. The computer readable medium of claim 12 further comprising the steps of:
prompting a user to enter an address associated with the transmission of the electronic communication message;
receiving the address; and
storing the address in the communication data parameter file.

16. The computer readable medium of claim 12 further comprising the step of:
formatting a shipping label based in part on the PLD data.

17. An apparatus comprising:
a database storing parcel level detail (PLD) shipping data in a plurality of records, the database further storing tracking number related data from which a tracking number can be derived, the database further storing a first and second destination address;
a processor receiving input comprising PLD data, the processor configured to store the PLD data in the database, the processor further configured to determine a tracking number based on the tracking number related data and store the tracking number in the database, the processor further configured to extract a subset of the PLD data and communicate the subset of PLD data and the tracking number to a second destination address; and
an interface for receiving from the processor the subset of PLD data and the tracking number and transmitting the tracking number over a communications network using the first address indicated by the processor.

18. The apparatus of claim 17 wherein the processor is further configured to communicate the tracking number using the first destination address based on a periodic schedule.

19. The apparatus of claim 17 wherein the processor is further configured to communication the PLD data to the second destination address.

20. The apparatus of claim 17 wherein the tracking number related data stored in the database comprises a plurality of tracking numbers.

21. The apparatus of claim 17 wherein the database further stores an extraction configuration file used to determine the subset of PLD data to be extracted.
